(19) United States
(12) Patent Application Publication
(10) Pub. No.: US 2025/0288154 A1
(43) Pub. Date: Sep. 18, 2025

(54) DEEP FRYER FOR REDUCING HARMFUL SUBSTANCES IN DEEP-FRIED GOODS

(71) Applicants: Harry OOSTEN, Eibiswald (AT); Evelyne OOSTEN, Eibiswald (AT)

(72) Inventors: Harry OOSTEN, Eibiswald (AT); Evelyne OOSTEN, Eibiswald (AT)

(21) Appl. No.: 18/860,465

(22) PCT Filed: Apr. 28, 2023
(86) PCT No.: PCT/EP2023/061295

§ 371 Date: Oct. 25, 2024

(30) Foreign Application Priority Data
Apr. 29, 2022 (AT) A 50290/2022

(51) Int. Cl. A47J 37/12

(52) U.S. Cl. CPC A47J 37/1223; A47J 37/1295

(57) ABSTRACT

A deep fryer for reducing harmful substances in deep-fried goods, including at least one frying container, at least one heat source arranged in and/or on the frying container, at least one frying oil circuit and at least one pump for pumping the frying oil in the frying oil circuit, the at least one frying oil circuit including a frying oil removal line which is connected to the frying container, at least one filter system which is connected to the frying oil removal line, and at least one frying oil return line which is connected to the filter system and the frying container, the frying oil return line having an outlet in the frying container. The frying container is connected to a frying oil overflow chamber via an overflow, the frying oil overflow chamber being connected to the frying oil removal line.

### CROSS-REFERENCE TO RELATED APPLICATIONS

The present application is a national phase application of PCT Application No. PCT/EP2023/061295, filed Apr. 28, 2023, entitled “DEEP FRYER FOR REDUCING HARMFUL SUBSTANCES IN DEEP-FRIED GOODS”, which claims the benefit of Austrian Patent Application No. A 50290/2022, filed Apr. 29, 2022, each of which is incorporated by reference in its entirety.

### BACKGROUND OF THE INVENTION

### 1. Field of the Invention

The invention relates to a deep fryer for reducing harmful substances in deep-fried goods and to a method for reducing harmful substances in deep-fried goods.

### 2. Description of the Related Art

It is well known that the frying medium of deep fryers, such as oil, must be replaced regularly, otherwise it will spoil over time. Furthermore, conventional deep fryers have a cold zone, which is usually located at the bottom of the frying container below the heat source. Frying residues can sink to the bottom of the frying container during the frying process and accumulate or remain in the cold zone. If the oil is not replaced and the frying residues are not removed from the cold zone, the frying residues, in particular breadcrumbs and other crumbs detached from the deep-fried goods, will continue to be heated, resulting in the formation of harmful substances, in particular acrylamide. Acrylamide is formed in the Maillard reaction during the overheating of starch, detectable acrylamide formation beginning at 120° C. and rising sharply at temperatures of 170-180° C. Acrylamide is said to have a strong genotoxic effect, which is why it is desirable to avoid or minimize the formation of this substance during frying in order to keep human exposure to this substance as low as possible when eating deep-fried goods.

The disadvantage of conventional deep fryers is that the entire frying oil has to be replaced to clean the bottom of the deep fryer of frying residues, which is costly and time-consuming and requires the deep fryer to be shut down. Such cleaning usually takes place in the evening after closing time. However, if the frying residues are not removed, they remain in the cold zone, and harmful chemical substances such as, in particular, the aforementioned acrylamide develop, causing the oil to spoil more quickly, and these harmful substances are absorbed when the deep-fried goods are consumed. Cleaning after closing time is therefore inadequate and very time-consuming.

### SUMMARY OF THE INVENTION

It is therefore the problem of the invention to provide a deep-fat fryer of the type mentioned at the beginning, with which the disadvantages mentioned can be avoided, with which the development of harmful chemical substances during deep-frying is reduced.

This has the advantage that the development of harmful chemical substances such as acrylamide during frying is greatly reduced. It has been shown that frying residues, such as loose parts of the breading of deep-fried goods, often float to the surface of the frying oil before they sink and lead to harmful chemical reactions. The frying oil overflow chamber with the overflow can therefore remove a large part of the frying residue from the surface of the frying oil from the frying container before it can sink. The overflowing frying oil is then cleaned by the filter system and returned to the frying container. This means that the frying oil has to be changed less often and that the frying oil is constantly cleaned. This can reduce the overall frying oil consumption as well as the harmful substance load of the deep-fried goods consumed.

It is therefore another problem of the invention to provide a method of the type mentioned at the beginning, with which the disadvantages mentioned can be avoided, with which the development of harmful chemical substances during deep-frying is reduced.

The advantages of the method correspond to the advantages of the deep fryer mentioned above.

The dependent claims relate to other advantageous embodiments of the invention.

Express reference is herewith made to the wording of the claims, whereby the claims are inserted into the description at this point by reference and are deemed to be reproduced verbatim.

### BRIEF DESCRIPTION OF THE DRAWINGS

The invention is described in more detail with reference to the enclosed drawings, in which only preferred embodiments are shown by way of example. Wherein:

FIG. 1 is a sectional view of a first preferred embodiment of the deep fryer;

FIG. 2 is a sectional view of a second preferred embodiment of the deep fryer; and

FIG. 3 is a top view of parts of the second preferred embodiment of the deep fryer.

### DETAILED DESCRIPTION

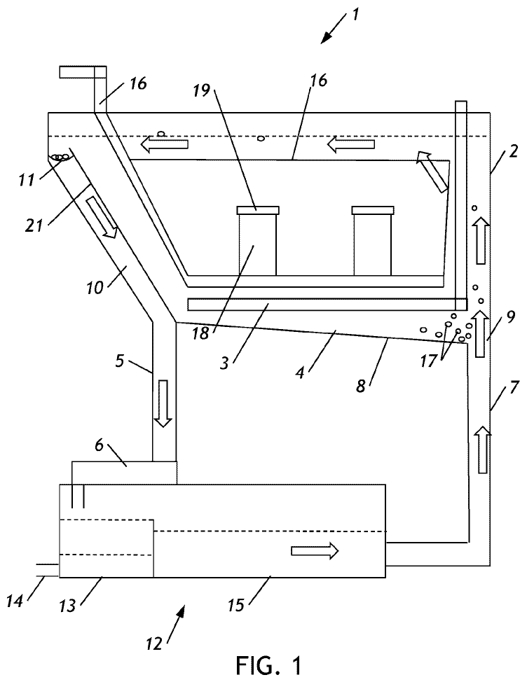

FIGS. 1 to 3 show at least parts of preferred embodiments of a deep fryer 1 for reducing harmful substances in deep-fried goods, comprising at least one frying container 2, at least one heating source 3 arranged in and/or on the frying container 2, at least one frying oil circuit and at least one pump 22 for pumping the frying oil 4 in the frying oil circuit, the at least one frying oil circuit comprising a frying oil removal line 5 connected to the frying container 2, at least one filter system 6 connected to the frying oil removal line 5 and at least one frying oil return line 7 connected to the filter system 6 and the frying container 2, the frying oil return line 7 having an outlet 9 in the frying container 2, characterized in that the frying container 2 is connected via an overflow to a frying oil overflow chamber 10, the frying oil overflow chamber 10 being connected to the frying oil removal line 5.

Furthermore a method is provided for reducing pollutants in deep-fried goods comprising a deep-frying system, wherein frying oil 4 is heated in a frying container 2, wherein deep-fried goods arranged in a deep-frying insert 16 are deep-fried, wherein frying oil 4 overflows from the frying container 2 via an overflow into a frying oil overflow chamber 10, frying oil 4 being removed from the frying oil overflow chamber 10 through a frying oil removal line 5 and cleaned by means of a filter system 6, cleaned frying oil 4 is being returned from the filter system 6 to the frying container 2 via a frying oil return line 7.

This has the advantage that the development of harmful chemical substances such as acrylamide during frying is greatly reduced. It has been shown that frying residues 17, for example loose parts of the breading of deep-fried goods, often float to the surface of the frying oil 4 before they sink and lead to harmful chemical reactions. The frying oil overflow chamber 10 with the overflow can therefore remove a large part of the frying residues 17 from the surface of the frying oil 4 from the frying container 2 before these residues can sink. The overflowing frying oil 4 is then cleaned by the filter system 6 and returned to the frying container 2. This means that the frying oil 4 does not have to be changed as often and the frying oil 4 is constantly cleaned. This can reduce overall consumption of the frying oil 4 as well as the harmful substance load of the deep-fried goods consumed.

It is also advantageous that energy can be saved, since the frying oil 4 does not have to be replaced frequently and thus heated from room temperature to an operating temperature, but heat remains in the frying oil 4 while it circulates in the frying oil circuit. Cleaning the frying oil 4 instead of replacing the entire frying oil 4 also saves resources.

A deep fryer 1 is a device for deep-frying deep-fried goods. Acrylamide is a known harmful substance that is produced when deep-frying deep-fried goods, in particular those containing starch. The frying container 2 is a container in which a frying medium 4, in particular oil or fat, is heated and in which the deep-fried goods are deep-fried. In particular, the frying container 2 can be designed as a trough. In one operating state, the frying container 2 is filled to a minimum level with frying oil 4. The surface of the frying oil 4 means the surface of the frying oil 4 filled in the frying container 2. For example, heating rods or one or more heating coils can be used as the heat source 3.

Preferably, the heat source 3 can be pivotably connected to a housing of the deep fryer 1. This allows the heat source 3 to be quickly removed from the frying container 2, if necessary.

The frying oil 4 is guided via the at least one frying oil circuit, at least one pump 22 pumping the frying oil 4 in the frying oil circuit. The at least one frying oil circuit comprises the frying oil removal line 5 connected to the frying oil overflow chamber 2, the at least one filter system 6 connected to the frying oil removal line 5, and the at least one frying oil return line 7 connected to the filter system 6 and the frying container 2. The frying oil removal line 5 removes the frying oil 4 to the filter system 6. Cleaned frying oil 4 is fed back into the frying container 2 by means of the frying oil return line 7. The filter system 6 has one or more filters.

The frying container 2 is connected to the frying oil overflow chamber 10 via the overflow. The frying oil 4 can drain out of the frying container 2 together with the floating frying residues 17 and thus be separated therefrom by means of the overflow. Frying oil 4 overflows into the frying oil overflow chamber 10 via the overflow or is swept by the frying oil flow via the overflow into the frying oil overflow chamber 10, where it enters the frying oil removal line 5.

In particular, the overflow can be arranged on one side of the frying container 2. In particular, the overflow can be arranged only on one side of the frying container 2. Alternatively, the overflow can be arranged on multiple sides of the frying container 2.

Preferably, the overflow of the frying oil overflow chamber 10 can extend over at least 50%, in particular at least 75%, in particular preferably at least 90%, of a side of the frying container 2 adjacent to the overflow. The overflow can preferably extend substantially over the entire abutting side. The abutting side is the side of the frying container 2 that is adjacent to the overflow. This allows the frying residues 17 to be separated from the frying container 2 particularly well and unhindered.

Preferably, the overflow can be arranged on a front side of the deep fryer 1 as seen in the operating position.

It is particularly preferable that the frying oil overflow chamber 10 is separated from the frying container 2 by a partition wall 21, an upper edge of the partition wall 21 forming the overflow. In this case, the frying container 2 and the frying oil overflow chamber 10 can be formed within a common trough, which is then divided into the frying container 2 and the frying oil overflow chamber 10 by the partition wall 21. This makes it easy to create a wide overflow.

Here, a longitudinal extension of the upper edge of the partition wall 21 can correspond to at least 50%, in particular at least 75%, particularly preferably at least 90%, of the width of the frying container 2.

In particular, the cross section of the frying oil overflow chamber 10 can be designed to be substantially constant.

Preferably, the partition wall 21 can be inclined, in particular inclined such that the frying container 2 tapers towards the bottom. This makes it easy to create an upward flow in the frying oil 4, from the bottom 8 in the direction of the overflow. Furthermore, this allows the deep fryer 1 to be compact.

In particular, at least one sieve 11 can be arranged in the frying oil overflow chamber 10. The sieve allows frying residues 17 to be easily retained in front of the filter system 6 and simply removed. Due to the frying oil flow, frying residues 17 are preferably swept from the bottom 8 of the frying container 2 to the surface of the frying oil 4 to the at least one sieve 11 and retained or collected in the at least one sieve 11. The sieve 11 is a coarse filter and is preferably arranged in the direction of flow or such that frying residues 17 floating on the surface of the frying oil 4 can easily enter the sieve 11. The sieve 11 can be removed and cleaned, if necessary.

As shown as an example in FIG. 1, the sieve can be arranged in the area of the overflow. This allows the sieve 11 to be cleaned easily.

It is particularly preferable that the sieve 11 is arranged in a lower area of the frying oil overflow chamber 10, and that an accumulation area for the frying oil 4 is formed above the sieve 11. The accumulation area is preferably an area above the sieve 11 in the frying oil overflow chamber 10, in which the frying oil 4 can accumulate. Due to a suitably selected pump capacity of the pump 22, the frying oil 4 accumulates in the frying oil overflow chamber 10 above the sieve 11, which prevents air from entering the frying oil removal line 5 during operation. This can reduce unwanted reactions of atmospheric oxygen with the frying oil 4 or the frying residues 17 in the frying oil removal line 5 and the filter system 6.

As an alternative to the partition wall 21, the frying oil overflow chamber 10 can be arranged at a distance from the frying container 2.

Preferably, the pump 22 can generate a frying oil flow during deep-frying. In particular, the frying oil flow can wash around the deep-fried goods.

The frying oil flow forced by the pump 22 can be adjusted such that, together with the flow generated by convection, it is sufficient to remove the frying residues 17 floating on the frying oil 4 and transport them in a targeted manner via the overflow of the frying oil overflow chamber 10 before the frying residues 17 can sink back into the deep fryer 1. Furthermore, the deep-fried goods are cooked evenly due to the even heat transfer. This means that deep-fried goods do not have to be turned and that the efficiency of the deep fryer 1 or the frying process is significantly increased.

The continuous removal of the frying residues 17 and the continuous filtering of the frying oil 4 can also reduce the formation of foam.

Furthermore, the frying oil flow or circulation of the frying oil 4 can easily transport moisture or water to the surface of the frying oil 4, where it can evaporate.

A series of tests has shown that by continuously removing the frying residues 17 from the surface of the frying oil 4, a 50% longer service life of the frying oil 4 could be achieved.

Preferably the filter system 6 can have at least one frying oil container 12, and the at least one frying oil container 12 can be connected to the frying oil return line 7. The frying oil container 12 is provided for the intermediate storage of the filtered frying oil 4.

Preferably the frying oil container 12 can have a separation chamber 13 with a frying oil overflow and a water drain 14, the separation chamber 13 being connected to a frying oil collecting chamber 15. In the separation chamber 13, water is separated from the frying oil 4 due to the widely known non-polar properties of oil in particular and the polar properties of water. The oil floats on the water and can overflow via the frying oil overflow, water being able to be drained through the water drain 14. Depending on the temperature of the frying oil 4, it can be cooled in the frying oil removal line 5 before and/or after the filter system 6 so that the separation of frying oil 4, in particular oil, and water functions satisfactorily. The separation of oil and water does not mean that water and oil must be completely separated, but that at least a large part of the moisture or water can be separated from the oil. This is advantageous, since a higher water content in the frying oil 4 favors splashing of the hot frying oil 4.

It may be particularly preferable for the frying oil removal line 5, the filter system 6, and the frying oil return line 7 to be designed as a closed system, whereby is prevented oxygen from entering the frying oil 4. This is advantageous because oxygen promotes harmful chemical reactions in the frying oil 4 and causes the frying oil 4 to spoil more rapidly.

In the case that a frying oil container 12 has a separation chamber 13, this chamber can also be arranged in the closed system to reduce the entry of oxygen into the frying oil 4.

The filter system 6 can have a filter which is arranged upstream of the frying oil container 12 in the direction of flow. One such embodiment is shown in FIG. 1.

However, it is also possible that the filter is combined with the frying oil container 12.

Particularly preferably, the filter system 6 has a frying oil container 12 with a fine filter 20, the fine filter 20 extending over at least a part of the upper side of a frying oil container 12.

The fine filter 20 can extend particularly over a large part, and particularly preferably substantially over the entire upper side of the frying oil container 12. This provides a large surface area on which the frying oil 4 can spread out on the fine filter 20. As a result, the fine filter 20 does not clog, even if it is very fine. The fine filter 20 can also become saturated with frying oil 4 during operation, forming a further barrier against the ingress of air into the frying oil container 12.

The fine filter 20 can be formed of fibers, preferably as a textile or nonwoven. This structure enables the fine filter 20 to retain particularly fine harmful substances.

The fine filter 20 can preferably be multi-layered.

Another coarse filter 23 can also be arranged on the fine filter 20. The coarse filter 23 can be substantially the same size as the fine filter 20. The coarse filter 23 can preferably be made of metal.

Preferably, the outlet 9 of the frying oil return line 7 can be designed as a nozzle, in particular as a flat nozzle. The outlet 9, which is designed as a nozzle, can be used to generate a strong frying oil flow inside the frying container 2. The flat nozzle can preferably have a horizontal nozzle gap. This allows a flow to be generated across the entire width, as shown schematically in FIG. 3.

It may be preferable for the overflow to be arranged at a distance from the frying oil return line 7.

It is particularly preferable for the outlet 9 of the frying oil return line 7 to be arranged opposite the overflow of the frying oil overflow chamber 10 in the frying container 2. This spacing of the overflow and the frying oil return line 7 creates a frying oil flow within the frying container 2, which substantially leads from the frying oil return line 7 to the surface of the frying oil 4, along the surface to an opposite side wall of the frying container 2, in particular the partition wall 21, and to the overflow. As a result, downtimes of the deep fryer 1 can be greatly reduced and, furthermore, frying can be carried out at a lower temperature due to the frying oil flow generated, since the deep-fried goods are always surrounded by frying oil 4, or the frying oil flow is guided past the deep-fried goods, which leads to good heat transfer within the frying container 2 from the frying oil 4 to the deep-fried goods. Furthermore, by rinsing or passing the frying oil flow past the deep-fried goods, frying residues 17 adhering to the deep-fried goods can also be removed, thereby cleaning the deep-fried goods.

In particular, the outlet 9 of the frying oil return line 7 can be arranged in a bottom area of the frying container 2, in particular at the bottom 8 of the frying container 2. As a result, frying residues 17 that have already sunk can be brought to the surface of the frying oil 4, where they can be separated via the overflow. This also allows the frying oil flow to be guided through the heating elements 3. A cold zone and water deposits in the cold zone are thus avoided, and the absence of the cold zone greatly reduces acrylamide formation, which means that the deep-fried goods are less contaminated with acrylamides.

It is particularly preferable that the bottom 8 slopes downwards towards the outlet 9 of the frying oil return line 7. The frying oil return line 7 can be connected to the frying container 2 at the bottom 8 of the frying container 2. The frying oil return line 7 is therefore connected to the bottom 8, and therefore also to the frying container 2, via the outlet 9. Frying oil 4 flows through the outlet 9 from the frying oil return line 7 into the frying container 2. Frying residues 17, which are detached from the frying products, sink to the bottom 8 and slide or slip along the sloping bottom 8 to the outlet 9 of the frying oil return line 7, where they are swept up by the frying oil flow and transported to the frying oil surface. It may be preferable that the bottom 8 slopes downwards towards the frying oil return line 7 or to the outlet 9 of the frying oil return line 7. Because the frying oil return line 7 is connected to the frying container 2 at the bottom 8 of the frying container 2, and the bottom 8 slopes down to the outlet 9 of the frying oil return line 7, frying residues 17 are carried along by the frying oil return flow from the bottom 8 and swept to the frying oil surface, from which they can be separated.

The above arrangement avoids a cold zone in the deep fryer 1. Frying residues 17, such as breadcrumbs and other crumbs, do not remain on the bottom 8 of the frying container 2, but are carried along by the generated frying oil flow and transported to the frying oil surface.

In the method, the frying container 2 has the bottom 8 sloping down to the outlet 9 of the frying oil return line 7, as a result of which frying residues 17 are carried along from the bottom 8 of the frying container 2 by the return flow of cleaned frying oil 4 and are swept to the surface of the frying oil 4 by the frying oil flow generated.

It may be particularly preferable that the outlet 9 of the frying oil return line 7 is connected to the frying container 2 at an edge area of the bottom 8. As a result, the bottom 8 can be beveled over a wide area or sloped towards the frying oil return line 7, whereby coarser frying residues 17 slide off as completely as possible towards the frying oil return line 7 or towards the outlet 9 of the frying oil return line 7, respectively.

Furthermore, due to flow effects, the frying oil flow generated in the frying container 2 also contributes to frying residues 17 sliding or slipping over the sloping bottom 8 to the frying oil return line 7.

It may also be preferable that the outlet 9 of the frying oil return line 7 is connected to the frying container 2 substantially at the lowest area of the bottom 8. This further reduces the risk of frying residue 17 remaining on the bottom 8 of the frying container 2.

It is possible that the heating source 3 is arranged such that it does not block the frying oil flow flowing from the frying oil return line 7 towards the frying oil surface.

In particular, the bottom 8 can be designed to slope downwards, particularly at an angle of no more than 100 to a horizontal plane. It has been shown that a flat sloping bottom 8 favors an undisturbed flow from the outlet 9 of the frying oil return line 7.

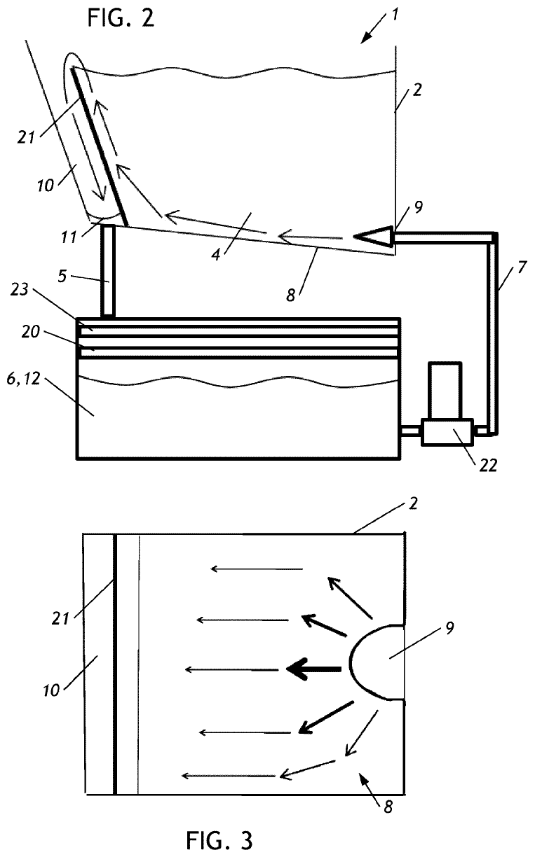

It is particularly preferable that the outlet 9 of the frying oil return line 7 is aligned with the bottom 8 of the frying container 2. As a result, the frying oil 4 coming out of the outlet 9 of the frying oil return line 7 is particularly good at detaching frying residues 17 from the bottom 8 and carrying them along in the frying oil flow. On the one hand, a flow can form along the bottom 8, which is deflected on the opposite side up to the overflow, and on the other hand a flow through the heating elements 3 can form, which is generated by natural convection. In the case of a sloping bottom 8, the outlet 9 can be arranged horizontally so that it is directed towards the bottom 8. Furthermore, the outlet 9 can be inclined downwards. On the one hand, this can achieve a good rinsing of the deep-fried goods and on the other hand, the removal of otherwise adhering frying residues 17. An example of such an embodiment is shown in FIG. 2.

Alternatively, the outlet 9 of the frying oil return line 7 is aligned towards an upper side of the deep fryer 1. This can generate a frying oil flow in the direction of the frying oil surface, whereby frying residues 17 can be carried up particularly well from the bottom 8 of the frying container 2 and transported to the frying oil surface in a targeted manner. Furthermore, convection currents of the hot frying oil 4 contribute to frying residues 17 rising to the surface of the frying oil or being swept up. An example of such an embodiment is shown in FIG. 1.

Preferably, the heating source 3 can be arranged at a maximum distance of 10 cm, preferably at a maximum distance of 7 cm, particularly preferably at a maximum distance of 5 cm, from the bottom 8 of the frying container 2. This close arrangement of the heat source 3 on the bottom 8 is particularly effective in preventing the formation of a cold zone and achieving continuous convection.

Preferably, the deep fryer 1 can also have a tool-free detachable electronic module for controlling and/or supplying power to the deep fryer 1. The electronic module has all the electrical components required to control the deep fryer 1 and can also be referred to as the control module. Preferably, the electronic module can also comprise a power supply unit.

If an electronic module is defective, it can be easily and quickly replaced by a user with another electronic module by means of Plug & Play to continue operating the deep fryer 1 and to minimize downtimes. No skilled electrician is required to replace this electronic module, which saves time and money.

Preferably, the electronic module can comprise a display with a touch screen to be able to easily adjust the control of the deep fryer 1.

Such a tool-free detachable electronic module also works in principle with any other deep fryer. A deep fryer 1 comprising at least one frying container 2, at least one heat source 3 arranged in and/or on the frying container 2, and an electronic module that can be detached without tools can be provided.

For this purpose, the deep fryer 1 can comprise a housing, the electronic module being insertable into a recess in the housing and repeatedly detachable from the housing in a non-destructive manner. For example, the electronic module can be connected to the rest of the deep fryer 1 using a Harting connector.

Furthermore, a deep-frying system comprising a deep-fryer 1 and at least one frying insert 16 is provided.

Preferably, the heating source 3 has a fastening device for the frying insert 16, such as a suspension rail, into which the frying insert 16 can be easily and quickly pushed in and pulled out therefrom.

It may also be preferable that flow baffles are arranged on the heat source 3 and/or on the frying insert 16, which baffles concentrate the heat on the deep-fried goods, thereby saving energy.

FIG. 1 shows an example of at least a part of a preferred embodiment of a deep-frying system having a frying container 2, a frying oil 4 arranged in the frying container 2, a heating source 3 inserted into the frying container 2, a frying oil removal line 5, a filter system 6 connected to the frying oil removal line 5, a frying oil container 12 connected to the filter system 6, the frying oil container 12 comprising a separation chamber 13, a water drain 14, and a frying oil collecting chamber 15, a frying oil return line 7 connected to the frying oil container 12, and a frying insert 16. The frying oil flow or frying oil circuit is indicated by arrows. A valve can preferably be arranged on the water drain 14. Frying residues 17 are indicated as examples by circles or ellipses. That portion of the flow of the frying oil 4 which does not spill over the overflow of the frying oil overflow chamber 10 flows down the outside of the frying oil overflow chamber 10 via the bottom 8 to the frying oil return line 7. This means that there is also a frying oil flow circuit within the frying container 2, whereby frying residues 17 on the bottom 8 are swept towards the flow of the frying oil return line 7 and carried along by the flow.

When the frying insert 16 is inserted in the frying container 2, frying oil 4 is displaced and removed via the frying oil removal line 5. If the frying insert 16 is removed, more frying oil 4 is pumped up to reach the minimum fill level again.

Preferably, the pump 22 can be least partially activated during deep-frying. In particular, the pump 22 can only be activated for part of the duration of the frying process.

Preferably, the pump 22 can be activated for a first predeterminable time period when the frying insert 16 is inserted into the frying container 2. The first predeterminable time period can preferably be between 5 s and 30 s. Many frying residues 17 are released from the deep-fried goods during the insertion process and can be separated in this way.

Furthermore, the pump 22 can also be activated at regular intervals during frying, in particular at intervals of between 30 s and 3 min, for a second predeterminable time period. The second predeterminable time period can preferably be between 5 s and 30 s. In particular, the second predeterminable time period can be shorter than the first predeterminable time period.

This allows regularly accumulating frying residues 17 to be removed.

In particular, the pump 22 can be activated for a third predeterminable time period after removal of the frying insert 16 from the frying container 2. The third predeterminable time period can preferably be between 5 s and 30 s. This means that the frying residues 17 that become detached during removal can also be removed.

The frying temperature can preferably be a maximum of 170° C., particularly preferably a maximum of 165° C. In this way, the production of acrylamides can be inhibited. The lower than usual frying temperature can be made possible in particular by the improved heat transfer between the frying oil 4 and the deep-fried goods due to the frying oil flow.

Particularly preferably, the pump capacity of the pump 22 can be set in such a way that a large part of the water escaping from the deep-fried goods evaporates before reaching the overflow. A pump capacity of 10 to 15 l/s has proven to be particularly preferable.

It is also preferable that a bottom cover is arranged directly on the bottom 8. This bottom cover can be easily removed from the frying container 2 after deep-frying and be cleaned. The bottom cover is designed such that a frying oil flow on the bottom 8 is not obstructed.

Particularly preferably, the frying oil container 12 can be provided with a contamination sensor for measuring a degree of contamination of the frying oil 4. In particular, the contamination sensor can be connected to the pump 22 by means of a circuit. If a predefined contamination value is exceeded, this can prevent the pump 22 from being activated.

Furthermore, the frying system can include an outlet for old frying oil 4 to dispose of it after multiple frying cycles.

In particular, the frying insert 16 can comprise a frying basket.

With conventional frying inserts 16, the problem can arise that the flow can be displaced from the inside of the batch if the deep-fried goods are introduced into the frying insert 16 as a batch, such as French fries. As a result, the deep-fried goods are fried faster on the underside or edge of the frying insert 16 compared to the inside of the frying insert 16.

A frying insert 16 with a frying basket is therefore preferably provided, having at least one downwardly open shaft 18 extending upwards from an underside of the frying basket. In this way, the frying oil 4 can pass unhindered through the shaft 18 into those areas of the frying insert 16 which makes it possible to fry the batch-like deep-fried goods evenly. Such a frying insert 16 is particularly suitable for use with the deep fryer 1 having the frying oil circuit, since the pump 22 in the frying oil circuit creates a particularly strong flow. However, such a frying insert 16 can also be used and be advantageous in conventional deep fryers without the frying oil circuit.

The wall of the at least one shaft 18 can in particular be designed as a grid. This allows the deep-fried goods to be kept out of the interior of the shaft 18, while the frying oil 4 can penetrate through the walls to the outside.

Alternatively, the wall of the at least one shaft 18 can be designed to be impermeable to the frying oil 4, at least one opening being arranged at an upper end of the shaft 18.

The at least one shaft 18 can, in particular, terminate at an intermediate height of the frying basket.

Preferably, the frying insert 16 can have multiple shafts 18.

The at least one shaft 18 can be arranged centrally within the frying basket. In this case, the shaft can preferably be evenly spaced from at least two opposite walls of the frying basket.

It is particularly preferable that a cover 19 is arranged at the upper end of the shaft 18, which cover 19 covers the shaft at the top. Due to the cover 19, the frying oil 4 cannot leave the shaft 18 unhindered upwards, but is deflected sideways into the deep-fried goods.

The following are principles for the understanding and interpretation of objective disclosure.

Features are usually introduced with an indefinite article “a, an.” Unless the context indicates otherwise, “a, an” is therefore not to be understood as a numeral.

An ordinal numeral, for example “first,” “second,” or “third,” is used in particular to distinguish a feature X or an subject matter Y in multiple embodiments, unless otherwise defined by the disclosure of the invention. In particular, a feature X or subject matter Y with an ordinal numeral in a claim does not mean that an embodiment of the invention falling under this claim must have another feature X or another subject matter Y.

“Substantially” in connection with a numerical value includes a tolerance of ±10% around the specified numerical value, unless the context indicates otherwise.

For value ranges, the end points are included, unless the context indicates otherwise.

1-15. (canceled)

16. A deep fryer for reducing harmful substances in deep-fried goods, comprising:
at least one frying container;
at least one heating source arranged at least one of in and on the frying container;
at least one frying oil circuit comprising:
a frying oil removal line connected to the frying container,
at least one filter system connected to the frying oil removal line, and
at least one frying oil return line connected to the filter system and the frying container, the at least one frying oil return line having an outlet in the frying container;
at least one pump for pumping the frying oil in the frying oil circuit; and
a frying oil overflow chamber, the frying container being connected to the frying oil overflow chamber via an overflow, the frying oil overflow chamber being connected to the frying oil removal line.

17. The deep fryer according to claim 16, wherein the overflow of the frying oil overflow chamber extends over at least 50% of a side of the frying container adjacent to the overflow.

18. The deep fryer according to claim 16, wherein at least one sieve is arranged in the frying oil overflow chamber.

19. The deep fryer according to claim 16, wherein the frying oil overflow chamber is separated from the frying container by a partition wall, an upper edge of the partition wall forming the overflow.

20. The deep fryer according to claim 16, wherein:
the filter system includes a frying oil container with a fine filter; and
the fine filter extends over at least a part of the upper side of a frying oil container.

21. The deep fryer according to claim 16, wherein the outlet of the deep fryer return line is configured as a nozzle.

22. The deep fryer according to claim 16, wherein the outlet of the frying oil return line is arranged in the frying container opposite the overflow of the frying oil overflow chamber.

23. The deep fryer according to claim 16, wherein the outlet of the deep fryer return line is arranged in a bottom area of the deep frying container.

24. The deep fryer according to claim 23, wherein the bottom slopes down to the outlet of the deep fryer return line.

25. The deep fryer according to claim 23, wherein the outlet of the deep fryer return line is substantially arranged at the deepest area of the bottom of the frying container.

26. The deep fryer according to claim 23, wherein the outlet of the deep fryer return line is aligned with the bottom of the frying container.

27. The deep fryer according to claim 16, wherein the heating source is arranged at a maximum distance of 10 cm from the bottom of the frying container.

28. A deep-frying system for reducing harmful substances in deep-fried goods, comprising:
at least one frying container;
at least one heating source arranged at least one of in and on the frying container;
at least one frying oil circuit comprising:
a frying oil removal line connected to the frying container,
at least one filter system connected to the frying oil removal line, and
at least one frying oil return line connected to the filter system and the frying container, the at least one frying oil return line having an outlet in the frying container;
at least one pump for pumping the frying oil in the frying oil circuit;
a frying oil overflow chamber, the frying container being connected to the frying oil overflow chamber via an overflow, the frying oil overflow chamber being connected to the frying oil removal line; and
at least one frying insert.

29. A method for reducing harmful substances in deep-fried goods, comprising:
heating frying oil in a frying container using at least one heating source arranged at least one of in and on the frying container;
arranging the deep-fried goods in a frying insert;
overflowing the frying oil from the frying container via an overflow into a frying oil overflow chamber;
removing the frying oil from the frying oil overflow chamber through a frying oil removal line connected to a filter system;
cleaning the frying oil by the filter system to form cleaned frying oil; and
returning the cleaned frying oil from the filter system to the frying container via a frying oil return line.

30. The method according to claim 29, wherein:
the frying container has a bottom sloping down to an outlet of the frying oil return line; and
frying residues from the bottom of the frying container are carried along by the cleaned frying oil and are swept to a surface of the frying oil by a generated frying oil flow.
